(19) United States
(12) Patent Application Publication
(10) Pub. No.: US 2013/0215179 A1
(43) Pub. Date: Aug. 22, 2013

(54) LIQUID DISCHARGE HEAD, AND LIQUID DISCHARGE HEAD DEVICE, LIQUID DISCHARGE APPARATUS AND PRINTING METHOD USING LIQUID DISCHARGE HEAD

(71) Applicant: Shin Ishikura, Kyoto-shi (JP)

(72) Inventor: Shin Ishikura, Kyoto-shi (JP)

(73) Assignee: KYOCERA CORPORATION, Kyoto-shi, Kyoto (JP)

(21) Appl. No.: 13/876,982

(22) PCT Filed: Sep. 29, 2011
(86) PCT No.: PCT/JP2011/072422

§ 371 Date: Mar. 29, 2013

(30) Foreign Application Priority Data
Sep. 29, 2010 (JP) 2010-219070

(51) Int. Cl. B41J 2/14

(52) U.S. Cl. CPC B41J 2/14
USPC 347/14; 347/54

(57) ABSTRACT

To provide a liquid discharge head usable in a non-horizontal state, and a liquid discharge head device, a liquid discharge apparatus and a printing method, each of which uses the liquid discharge head. The liquid discharge head includes a passage member and a plurality of pressurizing parts. The passage member includes a plurality of liquid discharge holes, a plurality of liquid pressurizing chambers connected correspondingly to the liquid discharge holes, and a plurality of common passages (manifolds) which are respectively connected to the liquid pressurizing chambers, and are independent of each other. Individual opening regions to cover locations that permit opening of the liquid discharge holes connected to one of the common passages occupy a smaller area than a liquid discharge hole opening region to cover locations that permits opening of all of the liquid discharge holes. The pressurizing parts pressurize the plurality of liquid pressurizing chambers, respectively.

### FIELD OF INVENTION

The present invention relates to a liquid discharge head to discharge liquid drops, in particular, a liquid discharge head which is fixed in its inclined state, or is used while its inclination angle is changed. The present invention also relates to a liquid discharge head device, a liquid discharge apparatus and a printing method, each of which uses the liquid discharge head.

### BACKGROUND

Recently, printing devices using inkjet recording method, such as inkjet printers and inkjet plotters, have been widely used in not only printers for general consumers but also industrial purposes, such as manufacturing of color filters for forming electronic circuits and for liquid crystal displays, and manufacturing of organic EL displays.

In the inkjet method printing device, a liquid discharge head for discharging liquid is mounted thereon as a printing head. For this type of printing head, thermal head method and piezoelectric method are generally known. That is, in the thermal head method, a heater as a pressing means is incorporated into an ink passage filled with ink, and the ink is heated and boiled by the heater. The ink is pressed by air bubbles occurred in the ink passage, and is then discharged as liquid drops through ink discharge holes. In the piezoelectric method, a partial wall of the ink passage filled with ink is bendingly displaced by a displacement element. The ink in the ink passage is mechanically pressed, and is discharged as liquid drops through the ink discharge holes.

The liquid discharge head can employ either a serial method or line method. That is, with the serial method, recording is carried out while the liquid discharge head is moved in a direction (main scanning direction) orthogonal to a conveyance direction (sub scanning direction) of a discharge object. With the line method, recording is carried out on the discharge object conveyed in the sub scanning direction in a state of fixing a liquid discharge head that is longer in the main scanning direction than the discharge object. Unlike the serial method, the line method need not move the liquid discharge head, thus having the advantage of performing high speed recording.

Even the liquid discharge head of either the serial method or the line method is required to increase the density of the liquid discharge holes for discharging the liquid drops which are formed in the liquid discharge head, in order to print the liquid drops with high density.

For this reason, a liquid discharge head that is long in one direction is known, which is configured by stacking a passage member having manifolds (common passages) and liquid discharge holes respectively connected from the manifolds via a plurality of liquid pressurizing chambers, and an actuator unit having a plurality of displacement elements respectively disposed to cover the liquid pressurizing chambers (refer to, for example, patent document 1). In this liquid discharge head, the liquid pressurizing chambers respectively connected to the liquid discharge holes are arranged in a matrix shape, and the displacement elements of the actuator unit disposed to cover the liquid pressurizing chambers are displaced to discharge ink from the individual liquid discharge holes, thereby allowing for printing at a resolution of 600 dpi in the main scanning direction.

### PRIOR ART DOCUMENT

### Patent Document

Patent document 1: Japanese Unexamined Patent Publication No. 2003-305852

### SUMMARY

### Problems to be Solved by the Invention

However, the liquid discharge head as described in the patent document 1 has suffered from a problem. That is, when this liquid discharge head is used in a situation where a liquid discharge hole surface that permits opening of the liquid discharge holes is not held horizontal, for example, under conditions that a longitudinal direction (a direction in which an object is long in one direction) is not horizontal, there occurs a large difference between a back pressure exerted on the liquid discharge hole located at one end in the longitudinal direction and a back pressure exerted on the liquid discharge hole located at the other end, making it difficult to bring these two liquid discharge holes into a dischargeable state.

Therefore, an object of the present invention is to provide a liquid discharge head that is usable in a non-horizontal state thereof, and also provide a liquid discharge head device, a liquid discharge apparatus and a printing method, each of which uses the liquid discharge head.

### Means for Solving the Problems

A liquid discharge head of the present invention includes a passage member and a plurality of pressurizing parts. The passage member includes a plurality of liquid discharge holes, a plurality of liquid pressurizing chambers connected correspondingly to the liquid discharge holes, and a plurality of common passages which are commonly connected to the liquid pressurizing chambers, and are independent of each other. Individual opening regions to cover locations that permit opening of the liquid discharge holes connected to one of the common passages occupy a smaller area than a liquid discharge hole opening region to cover locations that permit opening of all of the liquid discharge holes. The pressurizing parts pressurize the liquid pressurizing chambers, respectively.

A liquid discharge head device of the present invention includes the liquid discharge head, and a plurality of pressure adjustment parts which are respectively connected to the common passages of the liquid discharge head, and are capable of independently adjusting pressures of liquid supplied to the common passages.

A liquid discharge apparatus of the present invention includes the liquid discharge head device, a movable part that moves at least one of a discharge object and the liquid discharge head so as to change a relative position between the discharge object and the liquid discharge head, and a control part to control the liquid discharge head device and the movable part.

A printing method of the present invention uses a liquid discharge head. The liquid discharge head includes a passage member and a plurality of pressurizing parts. The passage member includes a plurality of liquid discharge holes, a plurality of liquid pressurizing chambers connected correspondingly to the liquid discharge holes, and a plurality of common passages which are commonly connected to the liquid pressurizing chambers, and are independent of each other. Individual opening regions to cover locations that permit opening of the liquid discharge holes connected to one of the common passages occupy a smaller area than a liquid discharge hole opening region to cover locations that permit opening of all of the liquid discharge holes. The pressurizing parts pressurize the liquid pressurizing chambers, respectively. The printing method includes discharging liquid on a discharge object by disposing the liquid discharge head in such a way that positions of the individual opening regions in a vertical direction are different from each other, and by applying a lower pressure to liquid in the common passage connected to the liquid discharge hole opened in the individual opening region located lower among the individual opening regions.

### BRIEF DESCRIPTION OF THE DRAWING(S)

FIG. 1 is a plan view of a passage member used for a liquid discharge head according to one embodiment of the present invention;

FIG. 2 is one partial plan view of the liquid discharge head using the passage member as shown in FIG. 1, with some passages omitted for the sake of explanation;

FIG. 3 is another partial plan view of the liquid discharge head using the passage member as shown in FIG. 1, with some passages omitted for the sake of explanation;

FIG. 4 is a longitudinal cross section taken along the line V-V in FIG. 2;

FIG. 5(a) is a schematic diagram of a liquid discharge head device according to one embodiment of the present invention; FIG. 5(b) is a schematic diagram of a liquid discharge head device without the scope of the present invention;

FIG. 6 is a schematic diagram for explaining a water head difference; and

FIG. 7 is a schematic diagram of an embodiment of other liquid discharge head device of the present invention.

### DETAILED DESCRIPTION OF THE PREFERRED EMBODIMENTS

### Preferred Embodiments for Carrying Out the Invention

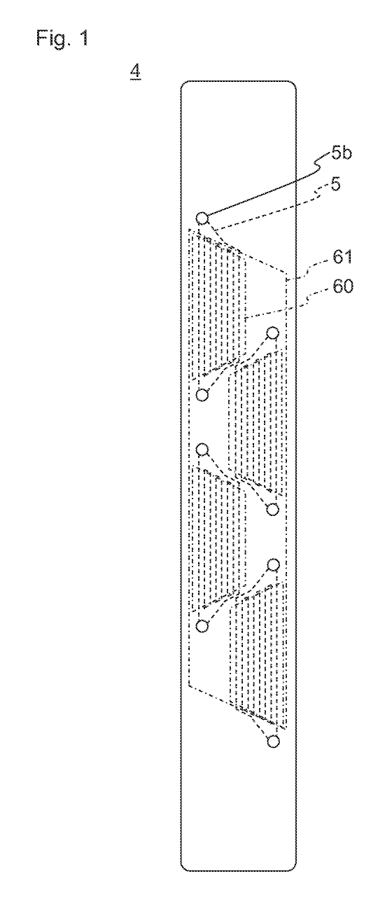

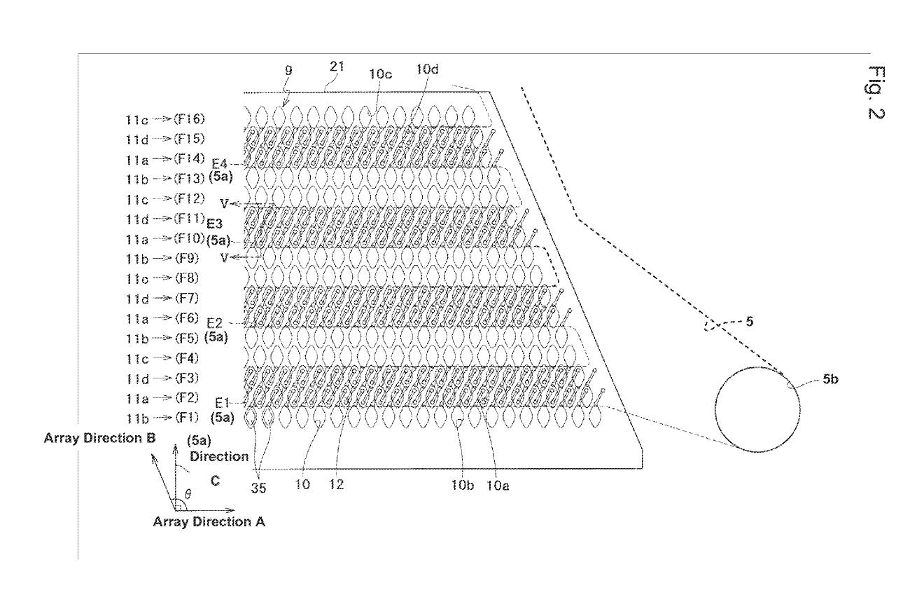

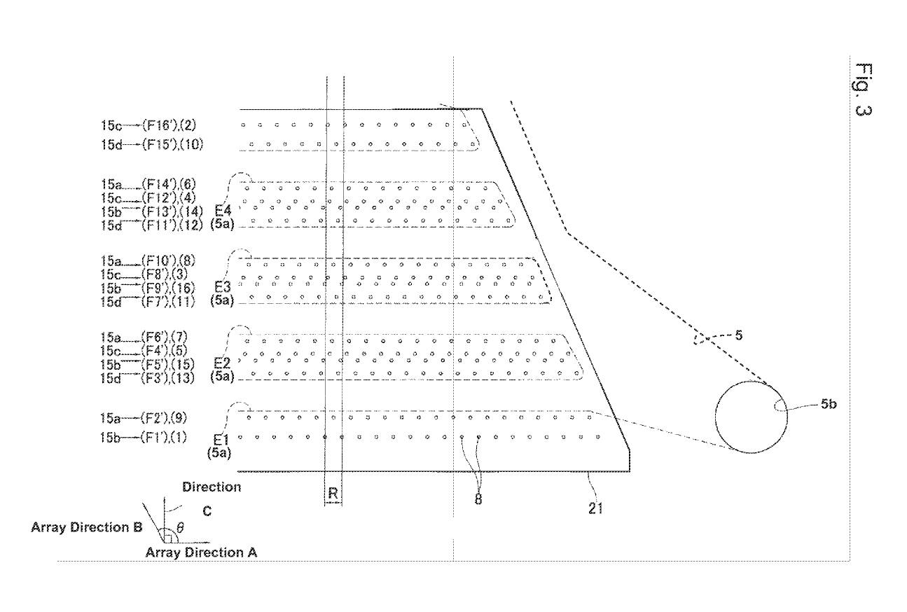

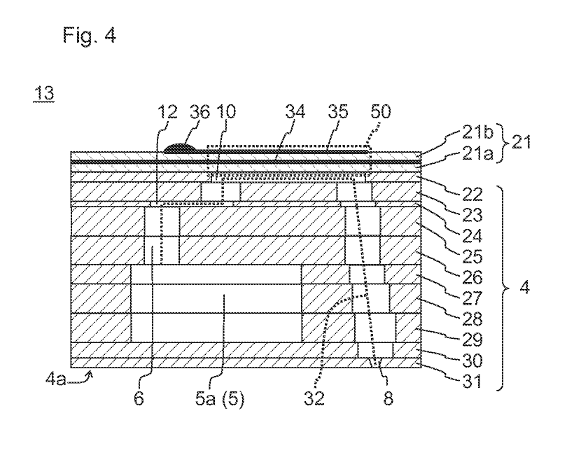

FIG. 1 is the plan view of a passage member 4 used in one embodiment of the present invention. FIG. 2 is the partial plan view of a liquid discharge head 13 having a piezoelectric actuator unit 21 connected to the passage member 4 shown in FIG. 1. Specifically, FIG. 2 is an enlarged perspective view taken at the same position as FIG. 3. In FIGS. 2 and 3, for the purpose of further clarification of the drawings, some passages are omitted, and liquid pressurizing chambers 10 (liquid pressurizing chamber groups 9), apertures 12, and liquid discharge holes 8, which are located below the piezoelectric actuator unit 21 and therefore should be drawn by broken lines, are drawn by solid lines. FIG. 4 is the longitudinal cross sectional view taken along the line V-V in FIG. 2.

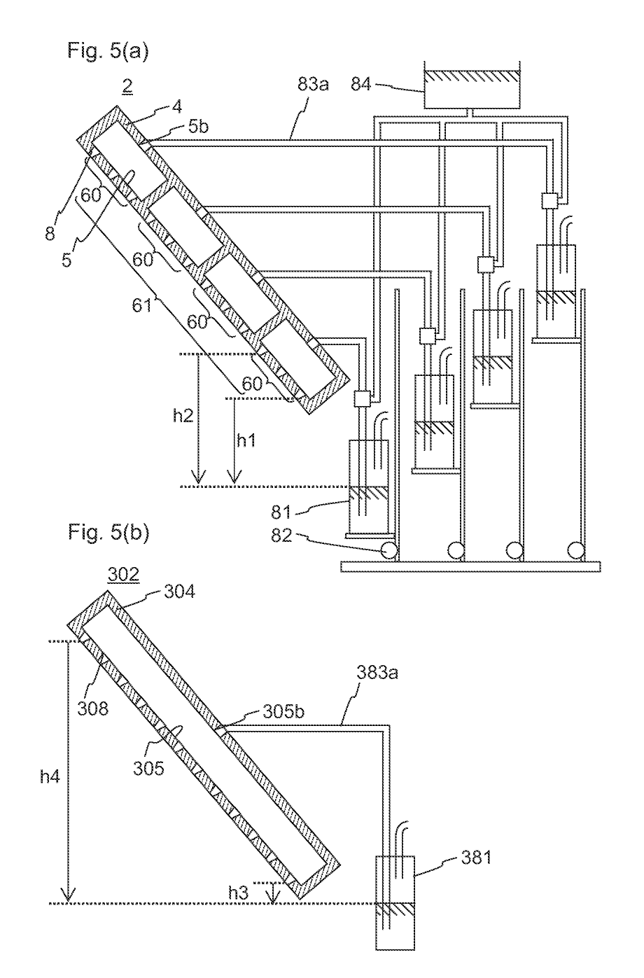

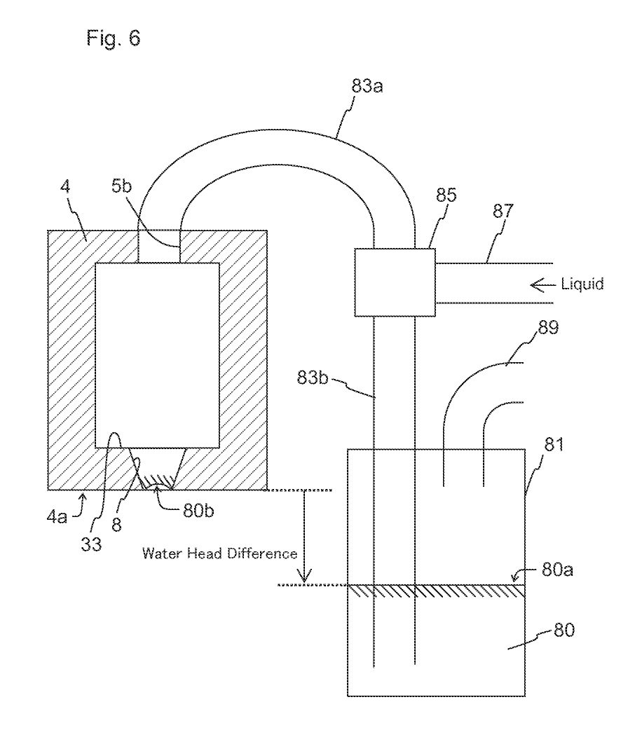

FIG. 5(a) is the schematic diagram of a liquid discharge head device 2 according to one embodiment of the present invention, in which the piezoelectric actuator unit 21 is omitted, and a passage structure of the passage member 4 is shown in simplified form. FIG. 6(b) is the schematic diagram of a liquid discharge head device 302 without the scope of the present invention, in which details are omitted similarly to FIG. 5(a)

In the liquid discharge head device 2 in FIG. 5(a), the passage member 4 has a plurality of manifolds 5 that are common passages from the liquid discharge holes 8 to feed orifices 5b. The manifolds 5 are independent of each other without being connected to each other. Relay tanks 81 that are external tanks are respectively connected via tubes 83a to the feed orifices 5b of these manifolds 5. The relay tanks 81 are respectively provided with motors 82 that are lift parts, and are operable in a vertical direction by activating the motors 82. A back pressure exerted on the liquid discharge holes 8 is adjustable by changing a relative height between the relay tanks 81 and the liquid discharge heads 13. One kind of liquid is supplied from one common tank to the individual relay tanks 81.

On the other hand, in the liquid discharge head device 302 without the scope of the present invention as illustrated in FIG. 5(b), a passage member 304 includes a manifold 305 extended from liquid discharge holes 308 to a feed orifice 385b. A relay tank 381 is connected via a tube 383a to the feed orifice 305b of the manifold 305.

Firstly, the back pressure and a water head difference in the liquid discharge head are described below. FIG. 6 is the schematic diagram for explaining the water head difference. In FIG. 6, an external liquid tank 81 is connected via tubes 83a and 83b to the passage member 4 having a liquid discharge hole surface 4a that permits opening of the liquid discharge hole 8 (an internal passage of the passage member 4 is shown in simplified form). An openable/closable valve 85 is disposed between the tubes 83a and 83b, and an external tube 87 is connected to the valve 85. The external liquid tank 81 stores liquid 80. A liquid surface 80a is the upper surface of the liquid 80 in the external liquid tank 81. The liquid 80 passes through the tubes 83a and 83b, and fills the manifold 5 in the passage member 4. The liquid 80 forms a meniscus 80b in the inside of the liquid discharge hole 8. The external liquid tank 81 is connected to the atmosphere via a tube 89, thereby exposing the liquid 80 to the atmosphere.

The liquid discharge head is configured to apply a negative pressure to the liquid in the passage during a discharge operation. This is called back pressure. When the pressure exerted on the meniscus 80b is a positive pressure, the liquid leaks out from the liquid discharge hole 8, and the shape of the meniscus 8b is unstable when no negative pressure is applied thereto, or the negative pressure is low. In contrast, when the negative pressure is too large, the meniscus 80b is drawn into the passage member 4, resulting in an unstable shape. In order to obtain an appropriate negative pressure, the liquid surface 80a is held low with respect to the liquid discharge hole surface 4a. A height difference between the liquid discharge hole surface 4a and the liquid surface 210a is referred to as a water head difference. The water head difference during the discharge operation is maintained at a negative value so that the back pressure becomes a negative pressure. It is essential to apply a negative pressure to the meniscus 80b. Hence, the meniscus 80b may be maintained by externally applying a pressure equivalent to the water head difference.

The liquid discharge head as illustrated in FIGS. 1 to 4 can discharge liquid drops, although depending on liquid used, by setting the water head different at approximately −70 to −20 mm when the liquid discharge hole surface 4a is held horizontal. Further, the water head difference needs to be set in a narrower range in consideration of circumstances where the liquid discharge holes 8 are required not only to discharge liquid drops but also to reduce the difference between them in liquid drops discharge characteristics, such as discharge rate and discharge quantity, and the liquid surface 80a is lowered by the amount of the discharged liquid.

The necessary back pressure is proportional to a surface tension of liquid and to a cosine of a contact angle between the liquid and the passage member 4, and is also proportional to the density of the liquid and the radius of the liquid discharge hole 8.

In the liquid charge head device 302 in FIG. 5(b), the liquid discharge holes 308 are formed over a length of 4 inches (approximately 101.6 mm). Therefore, when the liquid discharge head is disposed vertically, there is a difference of approximately 101.6 mm between a water head difference h3 in the liquid discharge hole 308 located at the lowest position at one end in a longitudinal direction at which the water head difference reaches its maximum value, and a water head difference h4 in the liquid discharge hole 8 located at the highest position at the other end in the longitudinal direction at which the water head difference reaches its minimum value. Thus, the water head difference between the two cannot fall within the range of −70 to −20 mm. Specifically, when the liquid discharge hole 308 located at the lowest position is set as a water head difference that permits liquid discharge, the meniscus of the liquid discharge hole 308 located at the highest position is drawn inward, thus failing to perform liquid discharge. In contrast, when the liquid discharge hole 308 located at the highest position is set as the water head difference that permits liquid discharge, the liquid flows out of the liquid discharge hole 308 located at the lowest position.

A region to cover locations that permits opening of the liquid discharge holes 8 connected to the single manifold 5 is hereinafter referred to as an individual opening region 60. The individual opening region 60 is basically a protruding polygon-shaped region in a plane. In the liquid discharge head device 2 illustrated in FIG. 5(a), the liquid discharge holes 8 connected to the single manifold 5 are formed over the individual opening region 60 having a length of approximately one inch (approximately 25.4 mm). Therefore, even when the liquid discharge head is disposed vertically, the water head difference thereof is approximately 25.4 mm. Accordingly, when a water head difference at a middle part of the individual opening region 60 is set at −45 mm, a water head difference hl in the liquid discharge hole 8 located at the lowest position at one end of the individual opening region 60, at which the water head difference reaches its maximum value, is approximately −32.3 mm. A water head difference h2 in the liquid discharge hole 8 located at the highest position at the other end of the individual opening region 60, at which the water head difference reaches its minimum value, is −62.7 mm. Both fall within the above range of −70 to −20 mm. Conversely, a water head difference range that allows for stable discharge can be seen from a relationship between the back pressure, and the liquid physical properties and the passage structure, or from test results. Therefore, the range of the individual opening region 60 may be designed so that both the water head difference of the liquid discharge hole 8 at the lowest position and the water head difference of the liquid discharge hole 8 at the highest position in the individual opening region 60 fall within an appropriate water head difference range at angles that can be formed by the liquid discharge head during printing.

A wide range printing can be performed within the appropriate water head difference range by configuring so that a liquid discharge hole opening region 61 to cover locations that permit opening of all the liquid discharge holes 8 is long in one direction, and the length of the individual opening region 60 in the one direction is shorter than the length of the liquid discharge opening region 61 in the one direction. In order to perform a wider range printing with a configuration that reduces a difference in the water head difference or causes the same water head difference, the liquid discharge hole opening region 61 needs to be divided by the individual opening regions 60 at substantially equal intervals in the one direction.

The arrangement of the individual opening regions 60 is illustrated in FIG. 1. Instead of this arrangement, the individual opening regions 60 having a rectangular shape or parallelogram shape may be arranged in a matrix shape. The individual opening regions 60 may not be completely independent of each other, or may be overlapped with each other. In either case, the area occupied by all the individual opening regions 60 is smaller than the area of the liquid discharge hole opening region 61 in which all the liquid discharge holes 8 are opened. In other words, a distance between the liquid discharge holes 8 separated from each other by the longest distance in each of all the individual opening regions 60 is shorter than a distance between the liquid discharge holes 8 separated from each other by the longest distance in the liquid discharge hole opening region 61.

The individual opening regions 60 allowing for adjustment of the back pressure are narrower than the liquid discharge hole opening region 61 as long as the above condition is satisfied. Therefore, an appropriate meniscus state can be maintained over the entire liquid discharge hole opening region 61 by adjusting the back pressure exerted on the manifolds 5 corresponding to the individual opening regions 60. In the absence of this structure, the pressure difference between the liquid discharge holes 8 is increased when the liquid discharge hole opening region 61 is long in one direction and is inclined in this direction. Hence, this structure is effective because it is highly effective particularly in reducing the pressure difference when a length of the individual opening region 60 in one direction thereof is shorter than a length of the liquid discharge hole opening region 61 in one direction thereof.

The foregoing liquid discharge head device 2 can also perform printing with one-color ink. That is, because the liquid discharge head device 2 can perform the stable wide-range printing, the same kind of liquid is preferably supplied to the individual manifolds 5 so as to fill them. Alternatively, color printing can also be performed using the four liquid discharge head devices by supplying inks of magenta (M), yellow (Y), cyan (C) and black (K) to the individual manifolds 5.

Alternatively, the liquid supplied to the relay tank 81 may be supplied individually instead of supplying the liquid from the common tank 84, thereby allowing the single liquid discharge head to discharge and print a plurality of kinds of inks. For example, the following embodiment can be considered. That is, the liquid discharge hole opening regions 61 are long in one direction, and the liquid discharge hole opening regions 61 that discharge one kind of ink are disposed over the entirety in the one direction of the liquid discharge hole opening region 61, and the liquid discharge hole opening regions 61 are arranged side by side in a direction orthogonal to the one direction. This embodiment produces a state similar to a conventional structure with respect to an inclination in the longitudinal direction, however, a pressure difference can be reduced with respect to an inclination in the transverse direction.

Subsequently, the details of the liquid discharge head are described. The liquid discharge head includes the planar passage member 4 and the piezoelectric actuator unit 21 disposed on the passage member 4. The piezoelectric actuator unit 21 has a trapezoidal shape, and is disposed on the upper surface of the passage member 4 so that a pair of parallel opposed sides of the trapezoidal shape are parallel to the longitudinal direction of the passage member 4. The two piezoelectric actuator units 21 along each of two virtual straight lines parallel to the longitudinal direction of the passage member 4, that is, a total of these four piezoelectric actuator units 21 are staggered on the passage member 4 in their entirety. Oblique sides of the piezoelectric actuator units 21 adjacent to each other on the passage member 4 are partially overlapped with each other in the transverse direction of the passage member 4. The liquid drops discharged from these two piezoelectric actuator units 21 are blended and land on a region in which these piezoelectric actuator units 21 corresponding to the overlapped portion are driven to perform printing.

The manifolds 5 that are a part of the manifolds 5 are formed inside the passage member 4. These manifolds 5 extend along the longitudinal direction of the passage member 4 and have a narrow long shape. The feed orifices 5b of these manifolds 5 are formed in the upper surface of the passage member 4. The five feed orifices 5b are formed along each of two straight lines (virtual lines) parallel to the longitudinal direction of the passage member 4, or a total of the ten feed orifices 5b are formed there. These feed orifices 5b are formed at locations except the region in which the four piezoelectric actuator units 21 are disposed. The liquid is supplied from the external liquid tank 81 to these manifolds 5 through these feed orifices 5b.

The manifolds 5 formed inside the passage member 4 are branched into a plurality of pieces (the manifolds 5 located at the branched portions are called sub manifolds 5a in some cases). The manifolds 5 respectively connected to the feed orifices 5b extend along the oblique sides of the piezoelectric actuator units 21, and are disposed intersecting the longitudinal direction of the passage member 4. These sub manifolds 5a are adjacent to each other in the region opposed to the individual piezoelectric actuator units 21 located inside the passage member 4, and extend in the longitudinal direction of the head body 13.

The manifolds 5 connected to the feed orifices 5b on both sides of the single piezoelectric actuator unit 21 are disposed limitedly to a region having substantially the same shape as this piezoelectric actuator unit 21. These manifolds 5 are not connected to the manifolds 5 connected to the feed orifices 5b on both sides of another piezoelectric actuator unit 21.

The passage member 4 includes four liquid pressurizing chamber groups 9, each having a plurality of the liquid pressurizing chambers 10 formed in a matrix shape (namely, two-dimensionally regularly). Each of these liquid pressurizing chambers 10 is a hollow region having a substantially rhombus planar shape whose corners are rounded. The liquid pressurizing chambers 10 are formed to be open in the upper surface of the passage member 4. These liquid pressurizing chambers 10 are arranged over substantially the entire surface of a region on the upper surface of the passage member 4 which is opposed to the piezoelectric actuator units 21. Therefore, each of the individual liquid pressurizing chamber groups 9 formed by these liquid pressurizing chambers 10 occupies a region having substantially same size and shape as the piezoelectric actuator unit 21. The openings of these liquid pressurizing chambers 10 are closed by the piezoelectric actuator units 21 adhered to the upper surface of the passage member 4.

In the present embodiment, as illustrated in FIG. 2, the manifolds 5 are branched into the sub manifolds 5a of four rows E1 to E4 arranged parallel to each other in the transverse direction of the passage member 4. The liquid pressurizing chambers 10 connected to these sub manifolds 5a constitute rows of the liquid pressurizing chambers 10 equally spaced in the longitudinal direction of the passage member 4. These rows are arranged in four rows parallel to each other in the transverse direction. Each of both sides of the sub manifold 5a is provided with two rows of the liquid pressurizing chambers 10 which are connected to the sub manifolds 5a and are arranged side by side.

These manifolds 5 are independent of each other. Hence, the foregoing structure is, in other words, one in which the liquid pressurizing chambers 10 are divided into a plurality of groups, the single manifold 5 is commonly connected to the liquid pressurizing chambers 10 that belong to the single group, and each of these liquid pressurizing chambers 10 is connected to the single corresponding liquid discharge hole. In the foregoing structure, the single manifold 5, the liquid pressurizing chambers 10 commonly connected from this manifold 5, and the liquid discharge holes 8 constitute one passage. The liquid discharge head has the four passages disposed independently from each other.

On the whole, the liquid pressurizing chambers 10 connected from the manifolds 5 constitute the rows of the liquid pressurizing chambers 10 equally spaced in the longitudinal direction of the passage member 4, and these rows are arranged in 16 rows that are parallel to each other in the transverse direction. The number of the liquid pressurizing chambers 10 included in each liquid pressurizing chamber row corresponds to the external shape of a displacement element 50 that is an actuator, and it is arranged so that the number thereof is gradually decreased from the long side to the short side. The liquid discharge holes 8 are also arranged similarly. This permits image formation at a resolution of 600 dpi in the longitudinal direction on the whole.

That is, when the liquid discharge holes 8 are projected to be orthogonal to virtual straight lines parallel to the longitudinal direction of the passage member 4, the four liquid discharge holes 8 respectively connected to the sub manifolds 5a, or a total of 16 liquid discharge holes 8 are equally spaced at 600 dpi in a range R of the virtual straight lines illustrated in FIG. 3. Individual passages 32 are respectively connected to these sub manifolds 5a at spaced intervals corresponding to 150 dpi on average. That is, when the liquid discharge holes 8 corresponding to 600 dpi are designed to be dividingly connected to four rows of the sub manifolds 5a, all the individual passages 32 respectively connected to these sub manifolds 5a are not connected to each other at equally spaced intervals. Therefore, the individual electrodes 32 are formed at spaced intervals of an average of not more than 170 μm (for 150 dpi, they are formed at spaced intervals of 25.4 mm/150=169 μm) in the extending direction of the sub manifolds 5a, namely, in the main scanning direction.

Individual electrodes 35 described later are respectively formed at positions opposed to the liquid pressurizing chambers 10 on the upper surface of the piezoelectric actuator unit 21. The individual electrodes 35 are slightly smaller than the liquid pressurizing chambers 10, and have a shape substantially similar to that of the liquid pressurizing chamber 10. The individual electrodes 35 are arranged to fall within the region opposed to the liquid pressurizing chambers 10 on the upper surface of the piezoelectric actuator unit 21.

A large number of liquid discharge holes 8 are formed in a liquid discharge surface on the lower surface of the passage member 4. These liquid discharge holes 8 are arranged at positions except the region opposed to the sub manifolds 5a arranged on the lower surface side of the passage member 4. These liquid discharge holes 8 are also arranged in regions opposed to the piezoelectric actuator units 21 on the lower surface side of the passage member 4. These individual opening regions 60 occupy a region having substantially the same size and shape as the piezoelectric actuator units 21. The liquid drops can be discharged from the liquid discharge holes 8 by displacing the displacement element 50 of the corresponding piezoelectric actuator unit 21. The liquid discharge holes 8 in their respective regions are arranged at equally spaced intervals along a plurality of straight lines parallel to the longitudinal direction of the passage member 4.

The passage member 4 included in the head body 13 has a laminate structure having a plurality of plates laminated one upon another. These plates are a cavity plate 22, a base plate 23, an aperture plate 24, supply plates 25 and 26, manifold plates 27, 28 and 29, a cover plate 30, and a nozzle plate 31 in descending order from the upper surface of the passage member 4. A large number of holes are formed in these plates. These plates are aligned and laminated so that these holes are communicated with each other to constitute the individual passages 32 and the sub manifolds 5a. As illustrated in FIG. 4, in the head body 13, the liquid pressurizing chamber 10 is disposed on the upper surface of the passage member 4, and the sub manifolds 5a are disposed inside on the lower surface side thereof, and the liquid discharge holes 8 are disposed on the lower surface thereof. Thus, the parts constituting the individual passage 32 are disposed close to each other at different positions, and the sub manifolds 5a and the liquid discharge holes 8 are connected to each other through the liquid pressurizing chambers 10. The lower surface of the passage member 4 corresponds to the liquid discharge hole surface 4a that permits opening of the liquid discharge holes 8.

The holes formed in the foregoing plates are described below. These holes can be classified into the following ones. Firstly, there are the liquid pressurizing chambers 10 formed in the cavity plate 22. Secondly, there are communication holes constituting passages connected from one end of each of the liquid pressurizing chambers 10 to the sub manifolds 5a. These communication holes are formed in each of the plates, from the base plate 23 (specifically, inlets of the liquid pressurizing chambers 10) to the supply plate 25 (specifically, outlets of the sub manifolds 5a). These communication holes include the apertures 12 formed in the aperture plate 24, and individual supply passages 6 formed in the supply plates 25 and 26.

Thirdly, there are communication holes constituting passages communicated from the other end of each of the liquid pressurizing chambers 10 to the liquid discharge holes 8. These communication holes are hereinafter referred to as descenders (partial passages). These descenders are formed in each of the plates, from the base plate 23 (specifically, outlets of the liquid pressurizing chambers 10) to the nozzle plate 31 (specifically, the liquid discharge holes 8). Fourthly, there are communication holes constituting the sub manifolds 5a. These communication holes are formed in the manifold plates 27 to 29.

These communication holes are connected to each other to form the individual passages 32 that extend from the inlets for the liquid from the sub manifolds 5a (the outlets of the sub manifolds 5a) to the liquid discharge holes 8. The liquid supplied to the sub manifold 5a is discharged from the liquid discharge hole 8 through the following route. Firstly, the liquid proceeds upward from the sub manifold 5a, and passes through the individual supply passage 6 and reaches one end of the aperture 12. The liquid then proceeds horizontally along the extending direction of the aperture 12, and reaches the other end of the aperture 12. Subsequently, the liquid proceeds upward from there and reaches one end of the liquid pressurizing chamber 10. Further, the liquid proceeds horizontally along the extending direction of the liquid pressurizing chamber 10, and reaches the other end of the liquid pressurizing chamber 10. The liquid then mainly proceeds downward while gradually moving from there in a horizontal direction, and proceeds to the liquid discharge hole 8 being opened in the lower surface.

In the present embodiment, the liquid discharge holes 8 included in the single individual opening region 60 are disposed in the same plane, and the manifolds 5 are disposed along the plane. The distance between the liquid discharge hole 8 and the manifold 5 is kept substantially constant. The passage structures from the manifolds 5 to the liquid discharge holes 8 are substantially the same in terms of passage characteristics. When used in a horizontal state, this configuration reduces variations in discharge characteristics for the liquid discharged from the liquid discharge holes 8. Further, the liquid can be stably discharged from the liquid discharge holes 8 by individually adjusting the pressures applied to the manifolds 5. Although in the present embodiment, all the liquid discharge holes 8 are disposed in the same plane, this is not necessarily essential. The liquid discharge holes 8 may be disposed on different planes (at different heights) for each of the individual opening regions 60, and the manifolds 5 may be disposed to have different heights so that the liquid discharge holes 8 being opened in the individual opening regions 60 and the manifolds 5 connected to these liquid discharge holes 8 are spaced apart substantially the same distance. In the liquid discharge head 13 so configured, the positions of the plurality of manifolds 5 in a vertical direction are sometimes different from each other when the plane of the single individual opening region 60 is held horizontal.

The piezoelectric actuator unit 21 has a laminate structure made up of two piezoelectric ceramic layers 21a and 21b, as illustrated in FIG. 4. Each of these piezoelectric ceramic layers 21a and 21b has a thickness of approximately 20 μm. The entire thickness of the piezoelectric actuator unit 21 is approximately 40 μm. Both the piezoelectric ceramic layers 21a and 21b are extended across the liquid pressurizing chambers 10 (refer to FIG. 2). These piezoelectric ceramic layers 21a and 21b are composed of ferroelectric lead zirconate titanate (PZT) based ceramic material.

Each of the piezoelectric actuator units 21 includes a common electrode 34 containing Ag—Pd based metal material or the like, and the individual electrode 35 containing Au based metal material or the like. As described above, the individual electrode 35 is disposed at the position opposed to the liquid pressurizing chamber 10 on the upper surface of the piezoelectric actuator unit 21. One end of the individual electrode 35 is drawn out beyond the region opposed to the liquid pressurizing chamber 10, thereby forming a connection electrode 36. The connection electrode 36 is composed of, for example, gold containing glass frit, and is protrudedly formed with a thickness of approximately 15 μm. The connection electrode 36 is electrically connected to an electrode mounted on an unshown FPC (flexible printed circuit). Although the details thereof are described later, a driving signal (driving voltage) is supplied from a control part via the FPC to the individual electrode 35. The driving signal is supplied on a fixed cycle in synchronization with a conveyance speed of a printing medium.

The common electrode 34 is formed over substantially the entire surface in a planar direction in a region between the piezoelectric ceramic layer 21a and the piezoelectric ceramic layer 21b. That is, the common electrode 34 is extended to cover all the liquid pressurizing chambers 10 in the region opposed to the piezoelectric actuator units 21. The thickness of the common electrode 34 is approximately 2 μm. The common electrode 34 is grounded and held at ground potential in an unshown region. In the present embodiment, a surface electrode (not illustrated) different from the individual electrodes 35 is formed at a position that is kept away from an electrode group made up of the individual electrodes 35 on the piezoelectric ceramic layer 21b. The surface electrode is electrically connected to the common electrode 34 via a through hole formed inside the piezoelectric ceramic layer 21b, and is connected to another electrode on the FPC similarly to the large number of individual electrodes 35.

As illustrated in FIG. 4, the common electrode 34 and the individual electrode 35 are arranged to hold therebetween only the piezoelectric ceramic layer 21b that is the uppermost layer. The region held between the individual electrode 35 and the common electrode 34 in the piezoelectric ceramic layer 21b is referred to as an active area, and the piezoelectric ceramics of the area is polarized. In the piezoelectric actuator units 21 of the present embodiment, only the uppermost piezoelectric ceramic layer 21b includes the active area, and the piezoelectric ceramic layer 21a does not include the active area, and acts as a vibrating plate. This piezoelectric actuator unit 21 has a so-called unimolf type configuration.

As described later, a predetermined driving signal is selectively applied to the individual electrode 35, thereby applying a pressure to the liquid in the liquid pressurizing chamber 10 corresponding to this individual electrode 35. Consequently, the liquid drops are discharged from the corresponding liquid discharge hole 8 through the individual passage 32. That is, the part of the piezoelectric actuator unit 21 which is opposed to the liquid pressurizing chamber 10 corresponds to the individual displacement element 50 (actuator) corresponding to the liquid pressurizing chamber 10 and the liquid discharge hole 8. Specifically, the displacement element 50 whose unit structure is the structure as illustrated in FIG. 4 is fabricated into a laminate body made up of these two piezoelectric ceramic layers in each of the liquid pressurizing chambers 10 by using the vibrating plate 21a, the common electrode 34, the piezoelectric ceramic layer 21b and the individual electrode 35, each of which is located immediately above the liquid pressurizing chamber 10. The piezoelectric actuator unit 21 includes a plurality of displacement elements 50. In the present embodiment, the amount of the liquid discharged from the liquid discharge hole 8 by a single discharge operation is approximately 5-7 pL (pico litter).

The large number of individual electrodes 35 are individually electrically connected to an actuator control means through a contact and wiring on the FPC so that their respective potentials can be controlled individually.

An example of a method of driving the piezoelectric actuator unit 21 during the liquid discharge in the present embodiment is described below with regard to the driving voltage (driving signal) supplied to the individual electrode 35. When the individual electrode 35 is set at a different potential from that of the common electrode 34, and an electric field is applied to the piezoelectric ceramic layer 21b in the polarization direction thereof, an area to which the electric field is applied acts as an active area that is distorted due to piezoelectric effect. At this time, the piezoelectric ceramic layer 21b expands or contracts in the thickness direction thereof, namely the stacking direction thereof, and attempts to contract or expand in a direction perpendicular to the stacking direction, namely, the planar direction by transverse piezoelectric effect. On the other hand, the other piezoelectric ceramic layer 21a is a non-active layer that does not include the region held between the individual electrode 35 and the common electrode 34, and therefore does not deform spontaneously. That is, the piezoelectric actuator unit 21 has a so-called unimolf type configuration in which the piezoelectric ceramic layer 21b on the upper side (namely, the side away from the liquid pressurizing chamber 10) is the layer including the active area, and the piezoelectric ceramic layer 21a on the lower side (namely, the side close to the liquid pressurizing chamber 10) is the non-active layer.

If in this configuration, the individual electrode 35 is set to a positive or negative predetermined potential with respect to the common electrode 34 by an actuator control part so that the electric field and the polarization are oriented in the same direction, the area (active area) held between the electrodes of the piezoelectric ceramic layer 21b contracts in the planar direction. On the other hand, the piezoelectric ceramic layer 21a as the non-active layer is not affected by the electric field, and therefore does not contract spontaneously, but attempts to restrict the deformation of the active area. Consequently, a difference of distortion in the polarization direction occurs between the piezoelectric ceramic layer 21b and the piezoelectric ceramic layer 21a, and the piezoelectric ceramic layer 21b is deformed and protruded toward the liquid pressurizing chamber 10 (unimolf deformation).

According to an actual driving procedure in the present embodiment, the individual electrode 35 is previously set at a higher potential than the common electrode 34 (hereinafter referred to as a high potential), and the individual electrode 35 is temporarily set at the same potential as the common electrode 34 (hereinafter referred to as a low potential) every time a discharge request is made, and thereafter is set again at the high potential at a predetermined timing. This allows the piezoelectric ceramic layers 21a and 21b to return to their original shape at the timing that the individual electrode 35 has the low potential, and the volume of the liquid pressurizing chamber 10 is increased compared to its initial state (the state that the potentials of both electrodes are different from each other). At this time, a negative pressure is applied to the inside of the liquid pressurizing chamber 10, and the liquid is absorbed from the manifold 5 into the liquid pressurizing chamber 10. Thereafter, at the timing that the individual electrode 35 is set again at the high potential, the piezoelectric ceramic layers 21a and 21b are deformed to be projected toward the liquid pressurizing chamber 10. Then, the pressure inside the liquid pressurizing chamber 10 becomes a positive pressure due to the reduced volume of the liquid pressurizing chamber 10, and hence the pressure applied to the liquid is increased to discharge the liquid drops. That is, a driving signal containing pulses using the high potential as reference is supplied to the individual electrode 35 for the purpose of discharging the liquid drops. An ideal pulse width is an AL (acoustic length) that is a length of time during which a pressure wave propagates from the manifold 5 to the liquid discharge hole 8 in the liquid pressurizing chamber 10. Thereby, when a negative pressure state inside the liquid pressurizing chamber 10 is reversed to a positive pressure state, both pressures are combined together, thus allowing the liquid drops to be discharged under a stronger pressure.

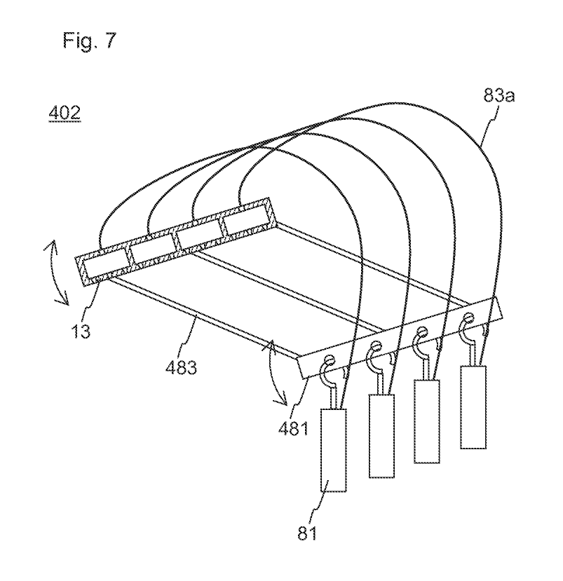

FIG. 7 is the schematic diagram of other liquid discharge head device 402 of the present invention. The relay tanks 81 are respectively attached to the liquid discharge head 402 with a relay tank attachment part 481 and an arm 483 interposed therebetween. Each of the manifolds inside the liquid discharge head 402 is connected to the relay tank 81 via a tube 83a, and liquid is supplied from the relay tank 81.

The arm 483, the liquid discharge head 402 and the relay tank attachment part 481 are rotatably connected to each other. Accordingly, when the liquid discharge head 402 is inclined, the arm 483 is inclined at substantially the same angle as the relay tank attachment part 481. The relay tank 81 is hooked over the relay tank attachment part 481, and is suspended from the relay tank attachment part 481. Owing to this configuration, a vertical distance from each manifold 5 inside the liquid discharge head 402 to the relay tank 81 connected from this manifold can be held substantially constant, thus ensuring stable printing.

As described above, the liquid discharge head of the present invention allows a plurality of pressure adjustment parts to independently adjust the pressure of the liquid supplied to the liquid discharge head. Therefore, the liquid discharge head can be used in a state that the liquid discharge hole surface 4a of the liquid discharge head is not held horizontal, by allowing the control part to control the pressure adjustment parts. That is, the liquid discharge head can be used in a state of being fixed obliquely or vertically. Accordingly, in a liquid discharge apparatus including the control part and a movable part that conveys a discharge object with respect to the liquid discharge head, it is capable of performing printing on the discharge object, whose printing surface cannot be held horizontal for some reason, by allowing the control part to control the pressure adjustment parts. Additionally, when a discharge object has a plurality of surfaces having different angles, it is possible to perform simultaneous printing on all these surfaces by using the plurality of liquid discharge heads. Further, in the case where a printing surface is not held horizontal when the liquid discharge head is incorporated in a discharging object manufacturing facility, the liquid discharge head can be directly incorporated therein in order to perform printing.

To be specific, printing on discharge objects, such as paper and fabric, can be carried out with the liquid discharge head inclined while the discharge objects are conveyed along a cylindrical surface, or the like.

Further, when printing is carried out while rotating and moving the liquid discharge head, and when the liquid discharge head is rotated and moved due to external factors, the printing can be carried out by allowing the pressure adjustment parts to independently adjust the pressure of liquid supplied to the liquid discharge head according to the state of the liquid discharge head. That is, the printing can be carried out when the angle of the liquid discharge head is changed in a serial type printing, for example, even when the printing head performs printing while rotatingly moving along the periphery of a columnar matter. Alternatively, printing on a discharge object can be carried out with the liquid discharge head attached to a robot arm by allowing for three-dimensional motion and angular change.

In either case, the control part may passively allow the pressure adjustment parts to adjust the pressure of liquid supplied to the liquid discharge head on the basis of inclination information about the liquid discharge head detected by a sensor part that detects an inclination of the liquid discharge head. Some examples of the sensor part are an inclination sensor, a plurality of position sensors, and a pressure sensor disposed in the supply passage. Alternatively, the control part may actively allow the pressure adjustment parts to adjust the pressure of liquid supplied to the liquid discharge head according to the posture of the liquid discharge head at those times, on the basis of data for operating an inclination mechanism that changes movement and angle of the liquid discharge head.

As used herein, the term “printing” may be one that performs substantially uniform printing on the printing surface, or one that performs printing images and characters by individually controlling the pressurizing parts.

The control part that controls the pressure adjustment parts is, for example, a computer program, which may be a part of the control part that controls components of the liquid discharge apparatus, or may be disposed separately from the control part that controls the components of the liquid discharge apparatus.

### DESCRIPTION OF REFERENCE NUMERALS

2, 302, 402 liquid discharge head device
4 passage member
4a liquid discharge hole surface
5, 305 common passage (manifold)
5a sub manifold
5b feed orifice (opening of manifold)
6 individual supply passage
8, 308 liquid discharge hole
9 liquid pressurizing chamber group
10 liquid pressurizing chamber
11a, 11b, 11c, 11d liquid pressurizing chamber row
12 aperture
13 liquid discharge head
15a, 15b, 15c, 15d liquid discharge hole rows
21 piezoelectric actuator unit
21a piezoelectric ceramic layer (vibrating plate)
21b piezoelectric ceramic layer
22-31 plates
32 individual passage
34 common electrode
35 individual electrode
36 connection electrode
50 pressurizing part (displacement element)
60 individual opening region
61 liquid discharge hole opening region
80 liquid
80a liquid surface in external liquid tank
80b meniscus (liquid surface in liquid discharge hole)
81, 381 external liquid tank (relay tank)
82 motor (lift part)
83a, 83b, 383a tube
84 common tank
85 valve
87 external tube
89 pipe
481 relay tank attachment part
483 arm

1. A liquid discharge head, comprising:
a passage member, the passage member comprising
a plurality of liquid discharge holes,
a plurality of liquid pressurizing chambers connected correspondingly to the liquid discharge holes, and
a plurality of common passages which are commonly connected to the liquid pressurizing chambers, and are independent of each other, wherein individual opening regions to cover locations that permit opening of the liquid discharge holes connected to one of the common passages occupy a smaller area than a liquid discharge hole opening region to cover locations that permit opening of all of the liquid discharge holes; and
a plurality of pressurizing parts to pressurize the liquid pressurizing chambers, respectively.

2. The liquid discharge head according to claim 1, wherein the liquid discharge hole opening region is long in one direction, and a length of the one direction of the individual opening region is shorter than a length of the one direction of the liquid discharge hole opening region.

3. The liquid discharge head according to claim 1, wherein identical liquid is supplied to the common passages.

4. A liquid discharge head device, comprising:
the liquid discharge head according to claim 1; and
a plurality of pressure adjustment parts which are respectively connected to the common passages of the liquid discharge head, and are capable of independently adjusting pressures of liquid supplied to the common passages.

5. The liquid discharge head device according to claim 4, wherein the pressure adjustment parts are connected to a common tank configured to store liquid discharged.

6. The liquid discharge head device according to claim 4, wherein each of the pressure adjustment parts comprises
a relay tank configured to store liquid discharged in a state that the relay tank is exposed to atmosphere, and
a lift part configured to vertically move the relay tank.

7. The liquid discharge head device according to claim 4, wherein the relay tank and the liquid discharge head are connected to each other so as to maintain a substantially constant vertical distance between the relay tank and the common passage configured to connect the relay tank thereto.

8. The liquid discharge head device according to claim 4, wherein
the liquid discharge head comprises the individual opening regions arranged to have different positions in a vertical position, and
the pressure adjustment parts are relay tanks configured to store liquid discharged in a state that the relay tanks are exposed to atmosphere, the relay tanks being arranged in such a way that the relay tank connected to the liquid discharge hole opened in the individual opening region located at a lower position among the individual opening regions is located at a lower position in the vertical direction.

9. The liquid discharge head device according to claim 4, further comprising:
a sensor part to detect an inclination of the liquid discharge head; and
a control part to control the plurality of pressure adjustment parts on a basis of information detected by the sensor part, in such a way that a pressure of liquid supplied to the common passages becomes lower in the common passage connected to the liquid discharge hole opened in the individual opening region located lower among the individual opening regions.

10. The liquid discharge head device according to claim 4, further comprising:
an inclination mechanism to change an inclination of the liquid discharge head; and
a control part to control the pressure adjustment parts in such a way that a pressure of liquid supplied to the common passages becomes lower in the common passage connected to the liquid discharge hole opened in the individual opening region located lower among the individual opening regions.

11. A liquid discharge apparatus, comprising:
the liquid discharge head device according to claim 4;
a movable part to move at least one of a discharge object and the liquid discharge head so as to change a relative position between the discharge object and the liquid discharge head; and
a control part to control the liquid discharge head device and the movable part.

12. A liquid discharge apparatus, comprising:
the liquid discharge head device according to claim 9; and
a movable part to move at least one of a discharge object and the liquid discharge head so as to change a relative position between the discharge object and the liquid discharge head, wherein
the control part controls the liquid discharge head device and the movable part.

13. The liquid discharge apparatus according to claim 11, wherein the movable part is configured to move the liquid discharge head so as to change a direction in which the liquid discharge holes are opened, with respect to a discharge object.

14. A printing method using a liquid discharge head, the liquid discharge head comprising:
a passage member, the passage member comprising
a plurality of liquid discharge holes,
a plurality of liquid pressurizing chambers connected correspondingly to the liquid discharge holes, respectively, and
a plurality of common passages which are commonly connected to the liquid pressurizing chambers, and are independent of each other, wherein
individual opening regions to cover locations that permit opening of the liquid discharge holes connected to one of the common passages occupy a smaller area than a liquid discharge hole opening region to cover locations that permit opening of all of the liquid discharge holes; and
a plurality of pressurizing parts to pressurize the liquid pressurizing chambers, respectively,
the printing method comprises discharging liquid on a discharge object by disposing the liquid discharge head in such a way that positions of the individual opening regions in a vertical direction are different from each other, and by applying a lower pressure to liquid in the common passage connected to the liquid discharge hole opened in the individual opening region located lower among the individual opening regions.

15. The printing method according to claim 14, comprising discharging liquid by moving the liquid discharge head so as to relatively change positions of the individual opening regions in a vertical direction, and by applying a lower pressure to liquid in the common passage connected to the liquid discharge hole opened in the individual opening region located lower among the individual opening regions according to movement of the liquid discharge head.
